(19) United States
(12) Patent Application Publication
(10) Pub. No.: US 2023/0122882 A1
(43) Pub. Date: Apr. 20, 2023

(54) PORT LOCK MODULE FOR ELECTRONIC DEVICE AND PORT LOCK APPARATUS INCLUDING SAME

(71) Applicant: COMXI Co., Ltd., Seoul (KR)

(72) Inventors: Byong Ju BAE, Asan-si (KR); Yong Un CHOI, Cheonan-si (KR)

(21) Appl. No.: 17/950,453

(22) Filed: Sep. 22, 2022

(30) Foreign Application Priority Data
Oct. 15, 2021 (KR) 10-2021-0137199

(51) Int. Cl. H01R 13/443

(52) U.S. Cl. CPC H01R 13/443; E05B 73/0082

(57) ABSTRACT

A port lock module for an electronic device includes a module frame formed by corresponding to size and shape of a port of an electronic device and having a frame shape having open opposite ends, the module frame having a main locking member configured to be transformed outward by an external force so as to be held in or released from a locking hole formed in the port, a locking module having a locking module body fixedly installed inside the module frame, and a sub-locking member connected to the locking module body such that the sub-locking member is elastically transformable, and a pattern module being installed to move inside and outside of the module frame between a locking position and an unlocking position.

### CROSS-REFERENCE TO RELATED APPLICATION

The present application claims priority to Korean Patent Application No. 10-2021-0137199, filed Oct. 15, 2021, which is incorporated herein by reference in its entirety.

### BACKGROUND

### 1. Technical Field

The present disclosure relates generally to a port lock module for an electronic device. More particularly, the present disclosure relates to a port lock module and a port lock apparatus including the same in which a port which is provided in an electronic device so as to be connected to an external device is physically locked.

### 2. Description of the Related Art

Recently, there have been incidents of outsiders breaking into financial institutions or government-affiliated institutions or non-administrators entering a computer thereof and withdrawing data stored in the computer, causing a great social impact, and in regard this, several countermeasures have been proposed.

In consideration of this, recently, various technologies have been proposed to physically lock a USB port of a computer, network equipment, an electronic product such that an unauthorized data transmission cable or connector is prevented from being connected thereto.

In addition, various methods and devices have been proposed to physically lock a LAN port connected with a LAN cable, that is, a network port such that data withdrawal through the network port is prevented.

To this end, the present applicant has developed a device for locking a USB port, a device for locking a LAN port, and a device for locking a network port lock, and the like.

Meanwhile, a lock device for physically locking the port of an electronic device includes a locking member that is inserted into the port to directly lock the port, and a key member used to remove the locking member from the port. Here, the key member is inserted into a key hole of the locking member to release the locked state of the locking member and to remove the locking member from the port, and is provided with a pattern key corresponding to a patterned depression formed inside a key depression. However, the pattern key and the patterned depression are designed and manufactured in various patterns for each lock device, and thus the locking member can be removed from the port by using only a key member having a pattern key matching the patterned depression of the locking member.

That is, after the pattern key is simply inserted into the key hole of the locking member and is held in the patterned depression, the pattern key is pulled, so the locking member can be removed from the port. However, in this case, even if the patterns of the patterned depression and the pattern key are not in agreement with each other, a portion of the pattern key is partially held in the patterned depression of the inside of the key hole, and thus the locking member may be forcibly removed from the port.

According, in consideration of this point, a lock device that can lock the port of an electronic device more securely is required to be developed.

### SUMMARY

Accordingly, the present disclosure has been made keeping in mind the above problems occurring in the related art, and the present disclosure is intended to propose a port lock module for an electronic device and a port lock apparatus including the same in which a port of an electronic device can be securely locked.

In order to achieve the above objective, according to one aspect of the present disclosure, there is provided a port lock module for an electronic device, the port lock module including: a module frame formed by corresponding to size and shape of a port of an electronic device and having a frame shape having open opposite ends, the module frame having a main locking member configured to be transformed outward by an external force so as to be held in or released from a locking hole formed in the port; a locking module having a locking module body fixedly installed inside the module frame, and a sub-locking member connected to the locking module body such that the sub-locking member is elastically transformable; and pattern module being installed to move inside and outside of the module frame between a locking position and an unlocking position, wherein when the pattern module is inserted to the locking position, the pattern module interferes with the main locking member such that the main locking member is held in the locking hole, the pattern module having a key depression into which an unlocking key for removing the sub-locking member from a holding jaw by which the sub-locking member is held is inserted.

Accordingly, the port of an electronic device may be easily locked by using the lock module.

Here, the locking module body may include: a horizontal part located between an upper wall and a lower wall of the module frame, wherein a fixing groove to which a fixing protrusion formed on the module frame is coupled is formed in each of opposite sides of the horizontal part, and a through hole is formed in a center of the horizontal part such that the sub-locking member connected to the horizontal part so as to be elastically transformable is received in the through hole; an entrance blocking part formed by extending upward from a front end of the horizontal part so as to partially block an entrance of the module frame; and a guide rib formed by protruding downward from each of opposite side edges of the horizontal part, wherein a guide groove which limits a reciprocating distance of the pattern module may be formed in the guide rib.

Accordingly, the locking module may allow the pattern module to be locked and unlocked while the pattern module moves relative to the locking module.

In addition, the main locking member may be formed to be inclined from the lower wall of the module frame toward the inside of the module frame such that the main locking member is in contact with the pattern module, the main locking member having a locking protrusion part locked in the locking hole of a port frame while the pattern module moving to the locking position moves in contact with a free end part of the main locking member.

Accordingly, the lock module may be effectively locked due to the configuration of the port.

In addition, the main locking member may be formed at a position corresponding to a position of an elastic piece formed on the lower wall of the port frame.

Accordingly, during the movement of the pattern module to the unlocking position, the main locking member may be restored to an initial position by the elastic piece of the port.

In addition, the sub-locking member may be formed to be inclined toward the pattern module from a first end of the sub-locking member connected to an inner wall of the through hole to a second end of the sub-locking member, wherein the second end of the sub-locking member may extend by protruding to a lower side of the locking module body such that the second end is held by the holding jaw formed in the pattern module moving to the locking position.

Accordingly, before using the unlocking key, the pattern module may not be moved to the unlocking position.

In addition, the pattern module may include: a plate-shaped pattern module body configured such that the key depression is exposed to front and lower surfaces of the pattern module body, and a guide protrusion formed by protruding from each of opposite side edges of the pattern module body, wherein a pattern part to which a pattern key of the unlocking key is coupled, and a holding key holding groove to which a holding key of the unlocking key is coupled may be respectively formed in inner different surfaces of the key depression, and a reception and guide groove for interfering with the main locking member may be formed in a lower part of the pattern module body.

Accordingly, the main locking member may be controlled to be locked and unlocked by manipulating the pattern module.

In order to achieve the above objective, a port lock apparatus of the present disclosure includes: the module frame formed by corresponding to size and shape of the port of an electronic device and having a frame shape having open opposite ends, the module frame having the main locking member configured to be transformed outward by an external force so as to be held in or released from the locking hole formed in the port; the locking module having the locking module body fixedly installed inside the module frame, and the sub-locking member connected to the locking module body such that the sub-locking member is elastically transformable; the pattern module being installed to move inside and outside of the module frame between the locking position and the unlocking position, wherein when the pattern module is inserted to the locking position, the pattern module interferes with the main locking member such that the main locking member is held in the locking hole, the pattern module having the key depression into which the unlocking key for removing the sub-locking member from the holding jaw by which the sub-locking member is held is inserted; and the unlocking key including: the pattern key inserted into the key depression by protruding from a front end of an unlocking key body so as to interfere with the sub-locking member such that the pattern module is removed from the locking module to be unlocked, and the holding key installed movably on an outer side of the pattern key and configured to expand inside the key depression to be held in the key depression such that the pattern module is moved to the unlocking position.

According to the port lock module for an electronic device of the present disclosure and the port lock apparatus including the same, in a state in which the port lock module is inserted into the port of an electronic device such as a USB, the port lock module may be prevented from being freely removed from the port, thereby securely locking the port of an electronic device.

In addition, the lock module locked by being coupled to the port may be removed from the port only by using the unlocking key having the pattern key formed in a pattern corresponding to the pattern part of the inside of the key depression of the lock module.

That is, when the pattern key of the unlocking key is completely inserted into the key depression of the lock module, the holding key may reach a position at which the pattern key can be held in a holding key holding groove of the inside of the key depression, the lock module may be prevented from being removed from the port by using a tool other than the unlocking key authorized previously. Accordingly, a port of an electronic device is more securely locked, thereby improving security.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view roughly illustrating the configuration of the port lock apparatus of the present disclosure;

FIG. 2 is a perspective view illustrating a lock module illustrated in FIG. 1;

FIGS. 3 and 4 are respectively exploded perspective views of the lock module illustrated in FIG. 2;

FIG. 5A is a perspective view illustrating a locking module of FIG. 3;

FIG. 5B is a bottom view of a state in which the locking module and a pattern module are coupled to each other;

FIG. 6 is a perspective view illustrating a state in which the locking module and the pattern module are coupled to each other;

FIG. 7 is a top plan view illustrating a state in which the pattern module of the lock module is located at an unlocking position;

FIG. 8 is a sectional view taken along line I-I of FIG. 7;

FIG. 9 is a sectional view taken along line II-II of FIG. 7;

FIG. 10 is a sectional view taken along line III-III of FIG. 7;

FIG. 11 is a top plan view illustrating a state in which the pattern module of the lock module is located at a locking position;

FIG. 12 is a sectional view taken along line IV-IV of FIG. 11;

FIG. 13 is a sectional view taken along line V-V of FIG. 11;

FIG. 14 is a sectional view taken along line NI-NI of FIG. 11;

FIG. 15 is a sectional view illustrating a state in which a pattern key and a holding key of an unlocking key are coupled to a key depression in the state of the key depression illustrated in FIG. 12;

FIG. 16 is a top plan view illustrating the unlocking key illustrated in FIG. 1;

FIG. 17 is a perspective view of the unlocking key illustrated in FIG. 16;

FIGS. 18 and 19 are exploded perspective views of the unlocking key illustrated in FIG. 16;

FIG. 20 is a top plan view illustrated by removing an upper casing of the unlocking key illustrated in FIG. 17;

FIG. 21A is a cross-sectional view illustrating a state of the unlocking key before a movable housing of the unlocking key is protruded;

FIG. 21B is a sectional view taken along line VII-VII of FIG. 20;

FIG. 22 is a top plan view illustrating a state in which the holding key is narrowed by moving a movable member in the state of the unlocking key illustrated in FIG. 20;

FIG. 23A is a perspective view illustrating a state in which a manipulation part, the pattern key, and the holding key illustrated in FIG. 18 are coupled to each other;

FIG. 23B is a top plan view of FIG. 23A;

FIG. 23C is a top plan view illustrating a state in which the holding key is narrowed by moving the movable member in FIG. 23B;

FIG. 24 is a bottom view illustrating a state in which the unlocking key is inserted into the key depression of the lock module;

FIG. 25 is a bottom view illustrating a state in which the holding key is opened in the state of FIG. 24; and

FIG. 27 is a bottom view illustrating a state in which the pattern module is moved to the unlocking position by using the unlocking key in the state of FIG. 26.

### DETAILED DESCRIPTION

Hereinafter, a port lock apparatus according to an embodiment of the present disclosure will be described in detail with reference to the accompanying drawings.

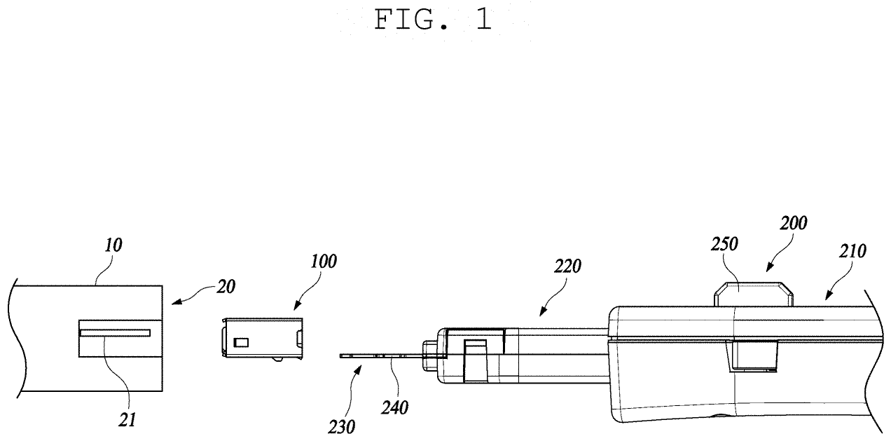

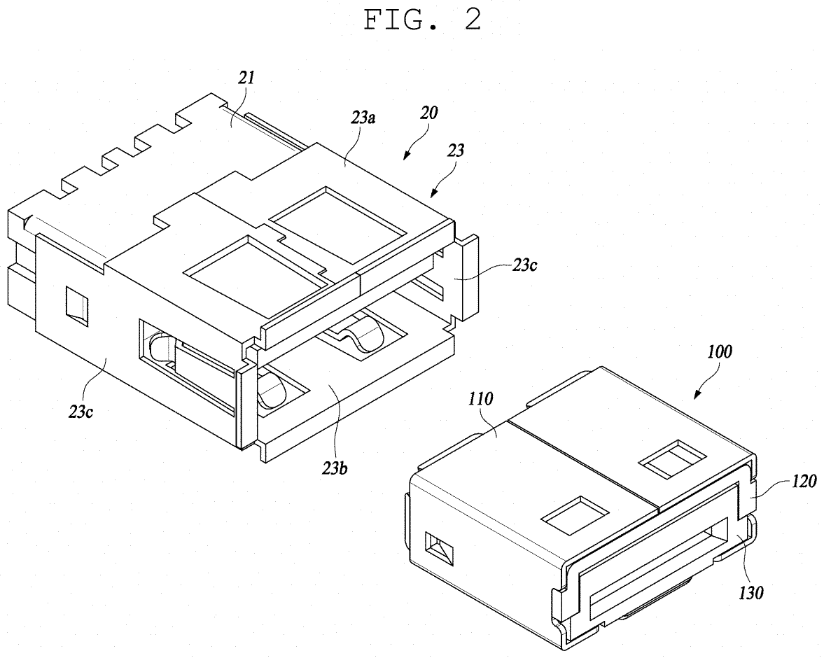

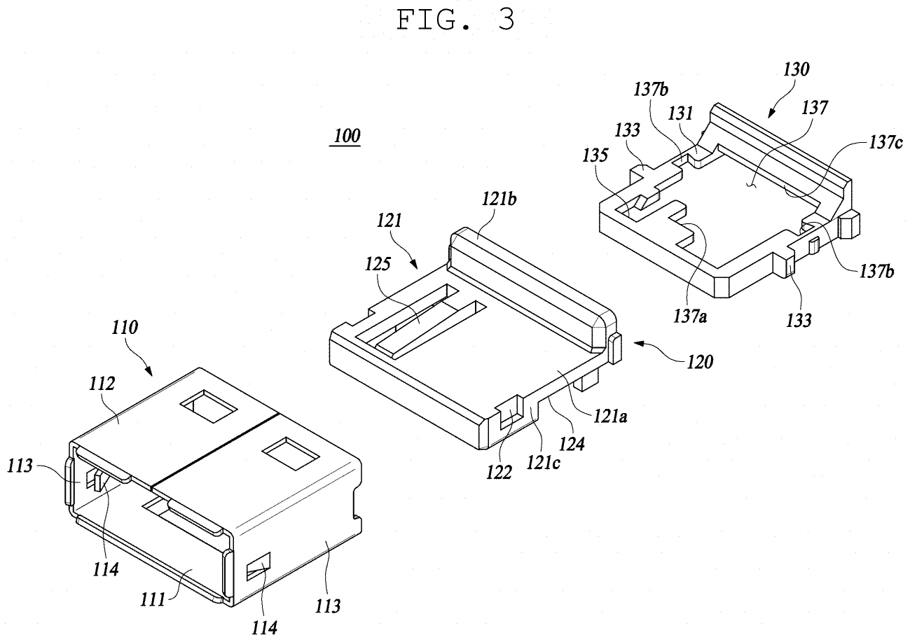

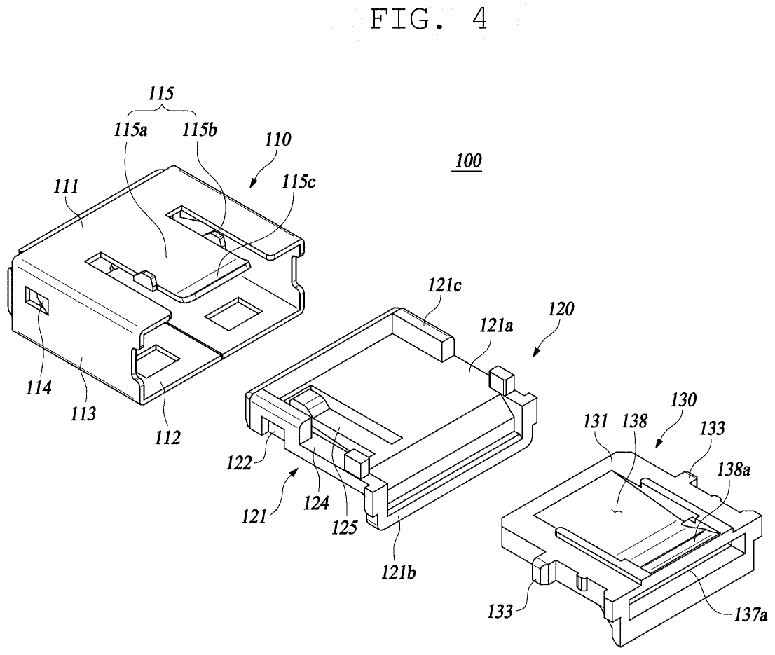

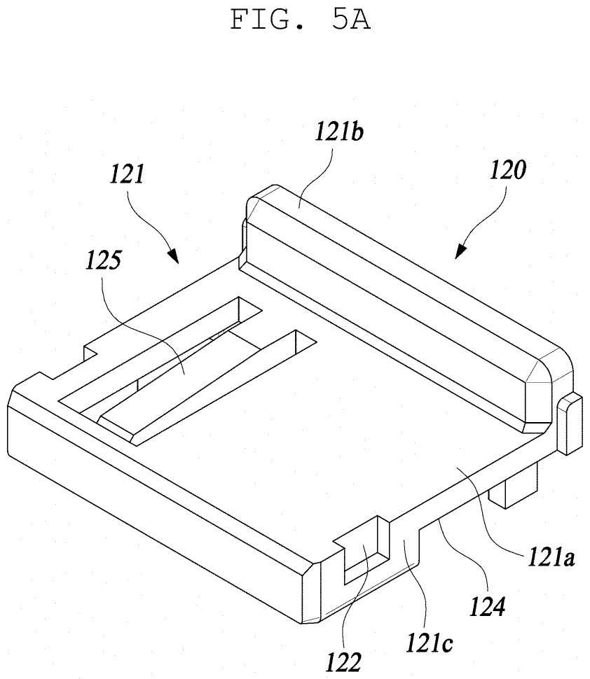

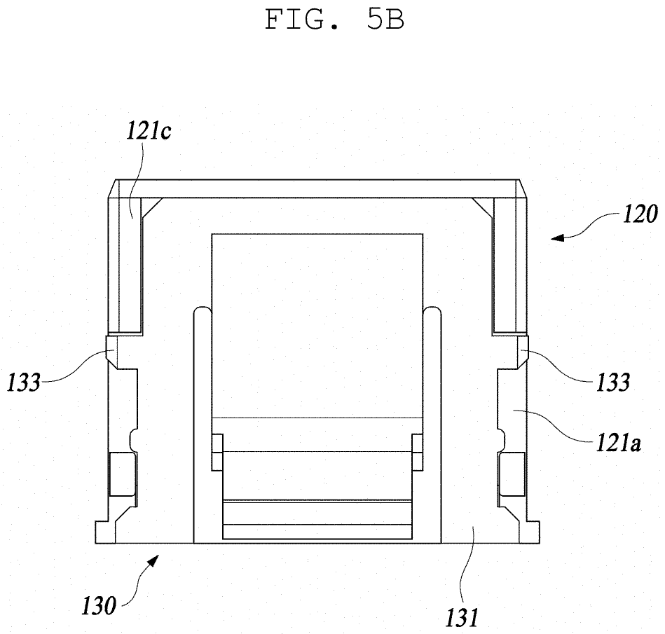

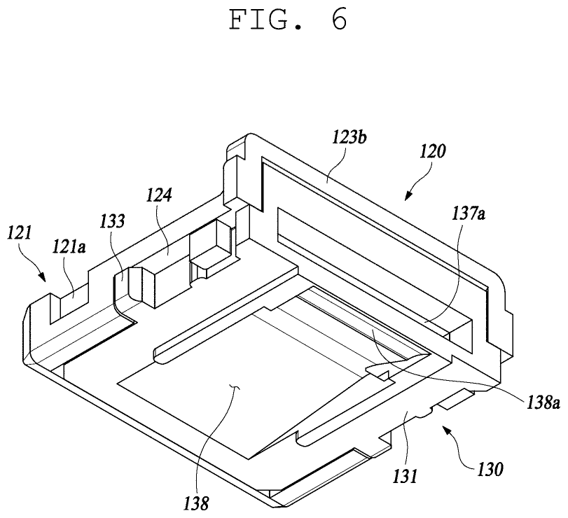

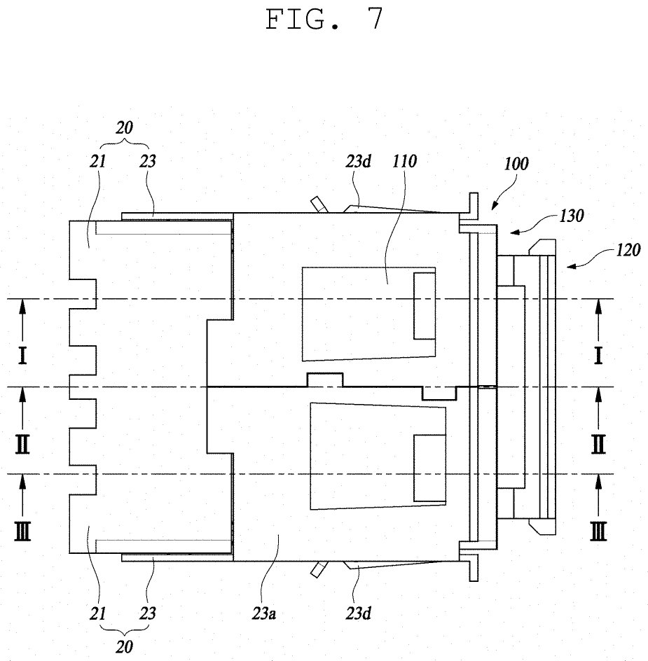

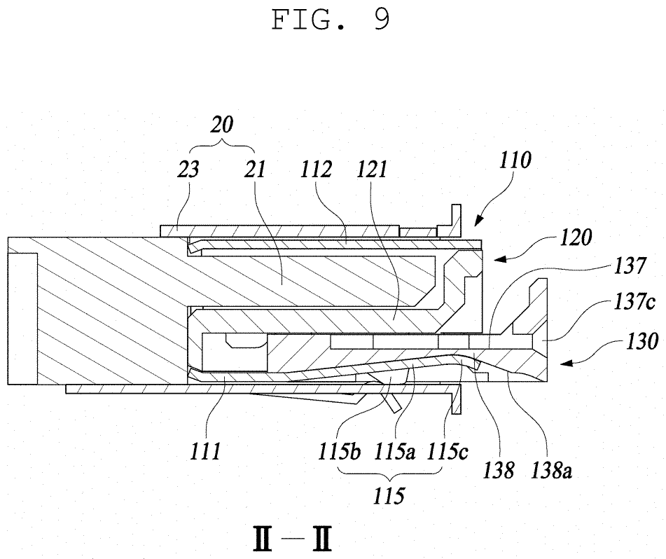

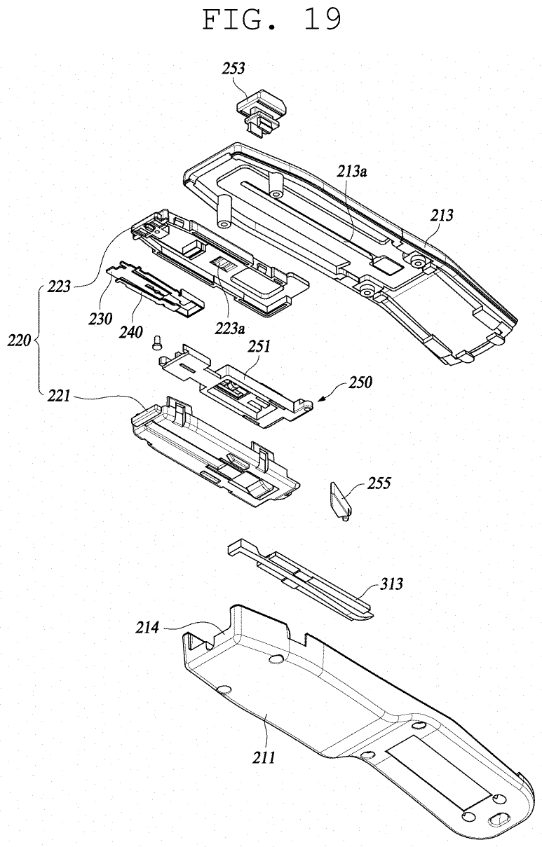

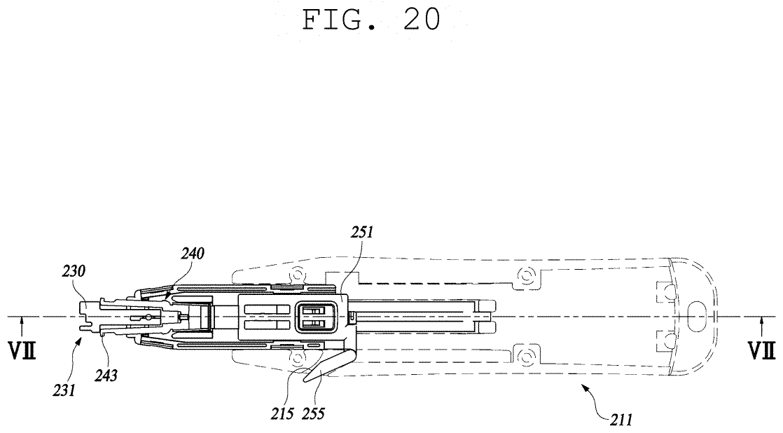

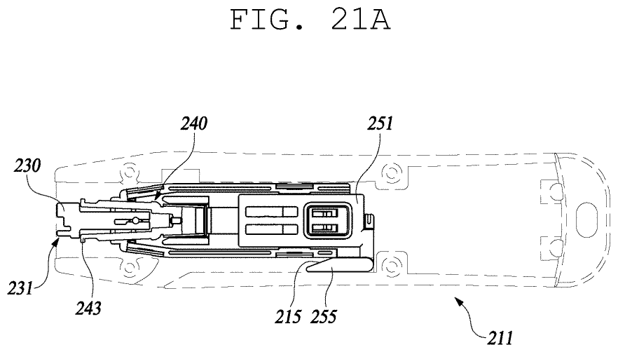

Referring to FIGS. 1 to 21B, the port lock apparatus according to the embodiment of the present disclosure is provided with a lock module 100 inserted into a port 20 of an electronic device 10 so as to lock the port 20, and the unlocking key 200 which unlocks the lock module 100 inserted into and coupled to the port 20 so as to remove the lock module 100 therefrom.

Here, the port 20 has a terminal module 21 connected to the electronic device 10, and a port frame 23 fixed to the electronic device 10 by covering the terminal module 21. The port frame 23 has the structure of a rectangular duct having an open front such that the port frame 23 has space into which a USB is inserted. The port frame 23 has an upper plate 23a, a lower plate 23b, and opposite side plates 23c, and a plurality of first elastic pieces 23d is installed on the lower plate 23b and the side plates 23c such that a USB inserted into the port frame can be elastically supported by the first elastic pieces. Furthermore, a second elastic piece 23e which can be elastically transformed to be moved inside and outside of a locking hole 23f is formed on the lower plate 23b.

The lock module 100 is provided with a module frame 110, a locking module 120 installed fixedly inside the module frame 110, and a pattern module 130 installed movably inside the module frame 110 such that the pattern module 130 can move relative to the locking module 120.

The module frame 110 has the shape of a rectangular frame open in the front and rear thereof and has a lower wall 111, an upper wall 112, and a pair of side walls 113. The module frame 110 is manufactured to have shape and size corresponding to the port 20 of an electronic device to be locked. A fixing protrusion 114 for fixing the locking module 120 is formed on each of the opposite side walls 113 by protruding inward therefrom.

In addition, a main locking member 115 is installed on the lower wall 111 of the module frame 110. The main locking member 115 is connected to the lower wall 111 in an end of the main locking member 115, and has an elastic part 115a having elasticity and a locking protrusion part 115b protruding downward from the elastic part 115a. A first end of the elastic part 115a is configured to be integrated with the lower wall 111, and a second end of the elastic part 115a, which is a free end part, is configured to be inclined gradually toward the inside of the module frame 110 toward the front of the module frame 110 and has the structure of an elastic piece which can be elastically transformed by an external force and restored. It is preferable that such an elastic part 115a is configured to be integrated with the lower wall 111, and is made of an elastic metallic material. In addition, a guide part 115c is provided on an end part of the elastic part 115a by bending outward from the inside of the module frame 110 to be inclined.

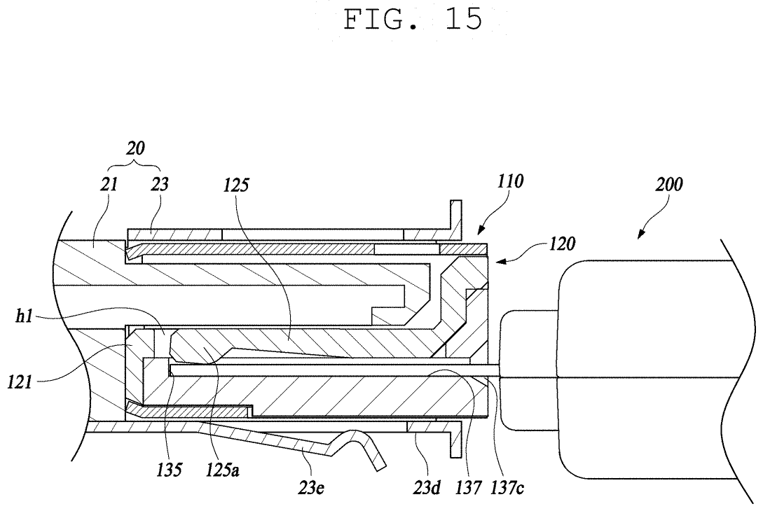

The locking protrusion part 115b is formed by protruding outward from each of the opposite edges of the elastic part 115a. As illustrated in FIG. 14, when the elastic part 115a inside the port 20 is elastically transformed outward, the locking protrusion part 115b is locked in the locking hole 23f formed in the port frame 23 such that the module frame 110 is not removed from the port 20.

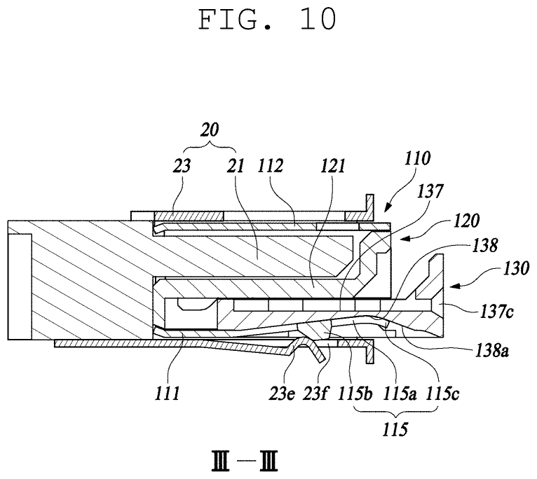

The main locking member 115 having such a configuration maintains a state protruding to the inside of the module frame 110 in a normal time (see FIG. 9), but when a pattern module 130 is completely inserted into the module frame 110, the guide part 115c interferes with the pattern module 130 and is elastically transformed outward, and thus the locking protrusion part 115b protrudes to the outside of the module frame 110 and may be locked in the locking hole 23f of the port frame 23 as described above.

The locking module 120 is provided with a locking module body 121 installed fixedly inside the module frame 110, and a sub-locking member 125 installed movably on the locking module body 121.

The locking module body 121 is provided with a horizontal part 121a located between the upper wall 112 and the lower wall 111 of the module frame 110, an entrance blocking part 121b formed by extending upward from the front end of the horizontal part 121a, and a guide rib 121c formed by protruding downward from each of the opposite side edges of the horizontal part 121a. A fixing groove 122 to which the fixing protrusion 114 of the module frame 110 is fitted and coupled is formed in each of the opposite surfaces of the horizontal part 121a. A guide groove 124 for limiting and guiding the reciprocating distance of the pattern module 130 is formed in the guide rib 121c.

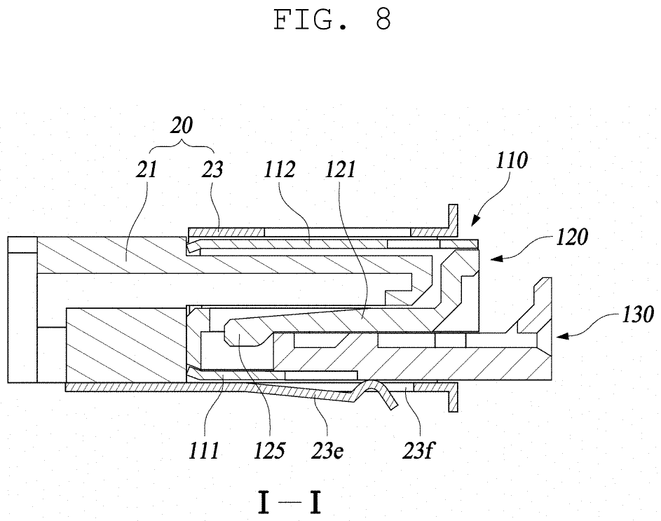

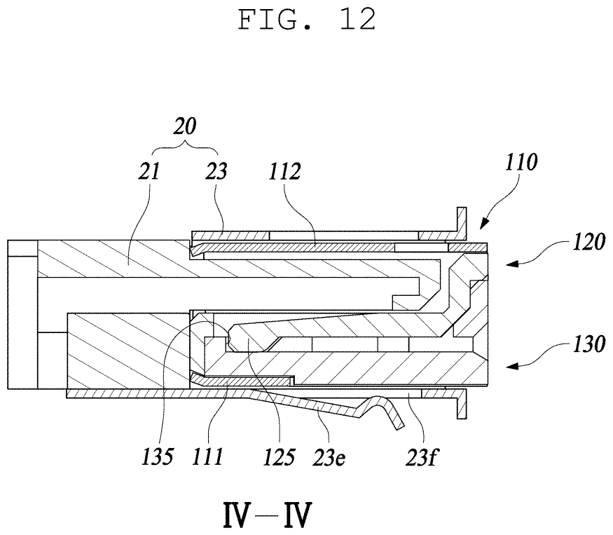

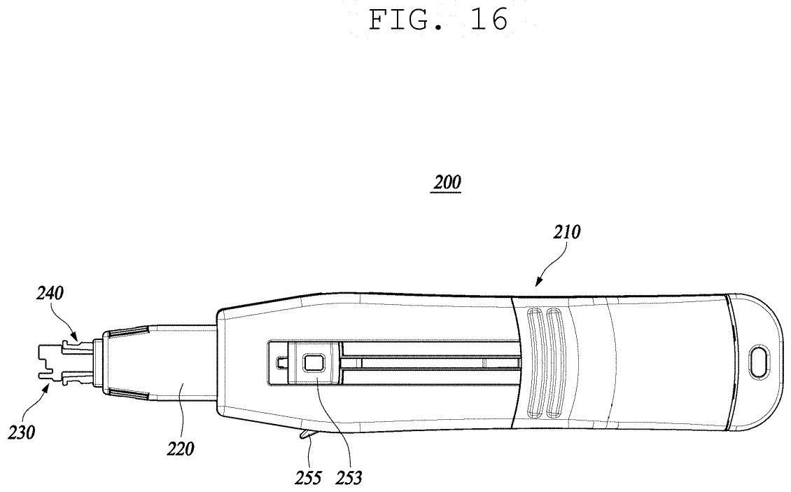

An end of the sub-locking member 125 is connected to the locking module body 121, and a free end part of the sub-locking member 125 extends by protruding to the lower side of the locking module body 121 (in a direction of approaching the pattern module). The end of the sub-locking member 125 is held in a holding jaw 135 famed in the pattern module 130. That is, as illustrated in FIG. 11, when the pattern module 130 is located at a locking position by being completely inserted into the module frame 110, the holding jaw 135 of the pattern module 130 is in contact with and held in the end of the sub-locking member 125. Accordingly, the unlocking key 200 may be used to push the sub-locking member 125 such that the sub-locking member 125 is removed from the holding jaw 135 (see FIG. 15). That is, as illustrated in FIG. 15, the sub-locking member 125 is pushed by a pattern key 230 of the unlocking key 200 inserted into a key depression 137 of the pattern module 130 and is unlocked by being out of the holding jaw 135. In this state, the pattern module 130 may be removed to an unlocking position (see FIGS. 7 to 10).

A through hole h1 in which the sub-locking member 125 is received is formed vertically through the locking module body 121. The sub-locking member 125 has an end connected to the inner wall of the through hole h1 and may be elastically transformed by an external force and restored.

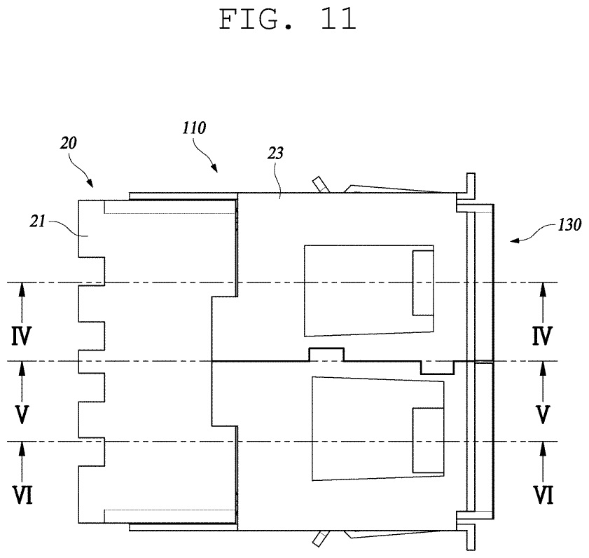

The pattern module 130 is coupled in a coupling space between the lower wall 111 of the module frame 110 and the locking module 120 such that the pattern module 130 can reciprocate. That is, the pattern module 130 may move between the locking position as illustrated in FIG. 14 and the unlocking position as illustrated in FIG. 10. The unlocking key 200 is required to be used such that the pattern module 130 moves from the locking position to the unlocking position. On the other hand, the pattern module 130 may be easily moved from the unlocking position to the locking position by pushing the pattern module 130 with a hand.

Such a pattern module 130 has a pattern module body 131 having a plate shape, and a guide protrusion 133 formed by protruding from each of the opposite edges of the pattern module body 131.

The key depression 137 into which the pattern key 230 and a holding key 240 of the unlocking key 200 are inserted is formed in the upper surface (a surface facing the locking module) of the pattern module body 131. The key depression 137 is exposed to the upper and front surfaces of the pattern module body 131. A pattern part 137a corresponding to the pattern of the pattern key 230 and a holding key holding groove 137b to which the holding key 240 is coupled are formed inside the key depression 137. The pattern part 137a is formed on the inner rear end surface of the key depression 137 corresponding to the entrance 137c of the key depression 137, and the holding key holding groove 137b is formed on each of the opposite surfaces of the key depression 137.

Furthermore, space in which the sub-locking member 125 of the locking module 120 is received is secured in the key depression 137 of the pattern module body 131. The holding jaw 135 in which a locking protrusion 125a of the sub-locking member 125 is held is formed on an end of the key depression 137. Accordingly, the end of the holding key 240 introduced into the key depression 137 is introduced up to the holding jaw 135 and may push the locking protrusion 125a such that the locking protrusion 125a is removed from the holding jaw 135.

In addition, a reception and guide groove 138 is formed in the lower surface of the pattern module body 131 so as to receive the main locking member 115 and control the main locking member 115 such that the main locking member 115 is elastically transformed. As illustrated in FIGS. 9 and 10, when the pattern module 130 is located at the unlocking position, the main locking member 115 is maintained to be in close contact with the inner surface of the reception and guide groove 138 while being received in the inner surface of the reception and guide groove 138, and thus the locking protrusion part 115b of the main locking member 115 is not locked in the locking hole 23f. In this state, the lock module 100 may be taken out from the port 20.

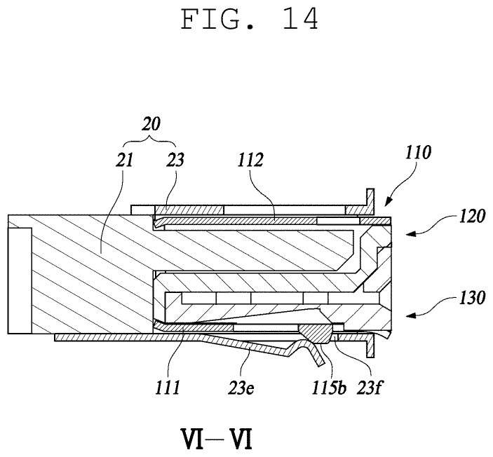

On the other hand, as illustrated in FIGS. 13 and 14, when the pattern module 130 is pushed into the module frame 110, the guide part 115c of the main locking member 115 interferes with an interfering inclined surface 138a of the reception and guide groove 138 and is elastically transformed and moved to the outside of the module frame 110. Accordingly, the locking protrusion part 115b is held in the locking hole 23f by protruding to the outside of the locking hole, so the lock module 100 may not be removed from the port 20.

In this case, the locking protrusion part 115b may interfere with and elastically transform the second elastic piece 23e (see FIG. 14) such that the locking protrusion part 115b is located in the locking hole 23f. Accordingly, the pattern module 130 is removed to the unlocking position by the unlocking key 200 to be described later, and the main locking member 115 is moved to an initial position by the elastic restoring force of the second elastic piece 23e as illustrated in FIG. 10.

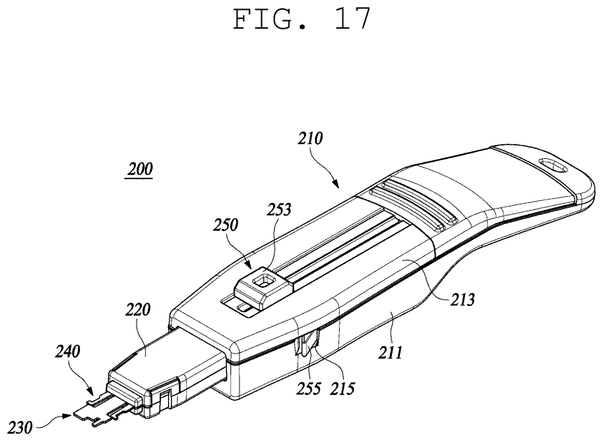

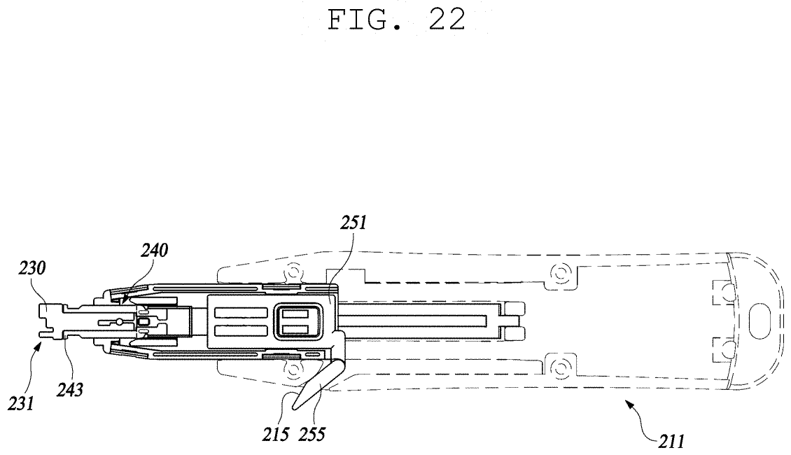

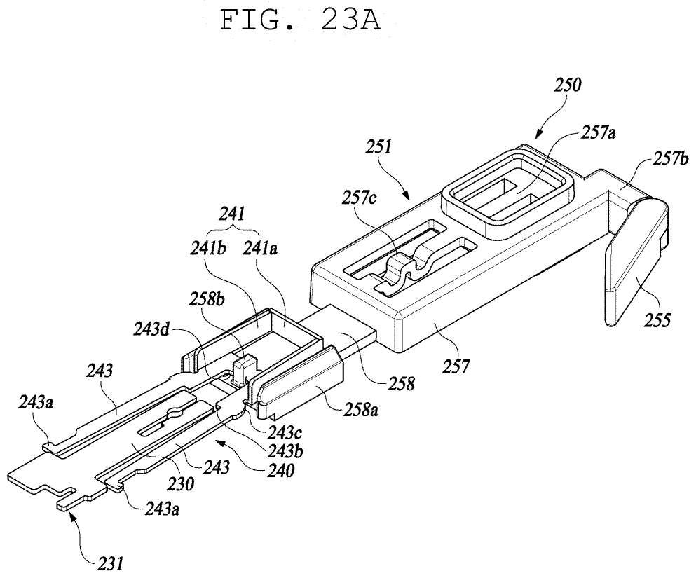

Referring to FIGS. 16 to 23C, the unlocking key 200 is provided with a body casing 210, a movable housing 220 installed to protrude to the front side of the body casing 210, the pattern key 230 protruding from the front end of the movable housing 220, the holding key 240 arranged on each of the opposite sides of the pattern key 230, and a manipulation part 250 for manipulating the movements of the movable housing 220 and the holding key 240.

The body casing 210 is provided with a lower casing 211 and an upper casing 213 which are coupled to each other. A fixing slit 211a is formed in the bottom of the inside of the lower casing 211. A guide member 212 is coupled to the fixing slit 211a. A stopper groove 212a is formed in the upper surface of the guide member 212. A guide slit 213a is formed in the upper casing 213 such that a main manipulation knob 253 of the manipulation part 250 is coupled to the guide slit 213a so as to reciprocate. The through hole 214 is formed in the front end of the body casing 210 such that the movable housing 220 can move inside and outside of the body casing 210.

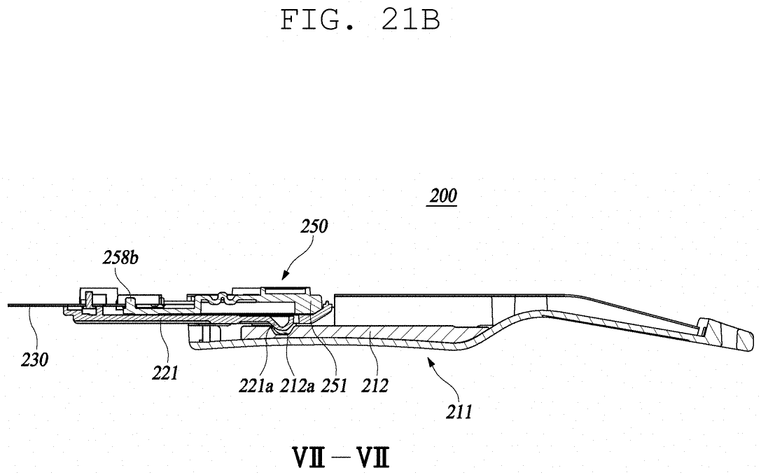

The movable housing 220 is installed in the body casing 210 such that the movable housing 220 can move inside and outside of the body casing 210 through the through hole 214 of the front end of the body casing 210. Such a movable housing 220 is provided with a lower housing 221 and an upper housing 223 which are coupled to each other. The lower housing 221 is slidably supported by the guide member 212. An elastic protrusion 221a is formed on the lower housing 221 by protruding downward therefrom such that the elastic protrusion is elastically inserted into and coupled to the stopper groove 212a of the guide member 212. Accordingly, when the movable housing 220 in the state of FIG. 21A is pushed and is protruded from the front end of the body casing 210 as illustrated in FIG. 21B, the elastic protrusion 221a is held in the stopper groove 212a and thus the position of the movable housing 220 can be fixed. In this state, when the main manipulation knob 253 is more pushed, a movable member 251 to be described later is more moved such that the movement of the holding key 240 can be controlled.

The pattern key 230 is fixed to the front end of the movable housing 220 by a screws or fixing pin such that the pattern key 230 is protruded therefrom. That is, a first end of the pattern key 230 is fixed to the movable housing 220 by a fastening means such as a bolt, and a second end of the pattern key 230 includes a key depression coupling part 231 having a pattern shape corresponding to the pattern part 137a of the key depression 137 of the pattern module 130. Such a pattern key 230 has a plate shape.

The holding key 240 includes a holding key body 241 installed inside the movable housing 220, and a holding key part 243 extending from the holding key body 241. The holding key body 241 has an approximate “U” shape, and a pair of elastic parts 241b bending and extending from opposite sides of a connection part 241a relative to the connection part 241a such that the elastic parts 241b face each other. The holding key part 243 is formed integrally with an end part of the elastic parts 241b by bending and extending therefrom. Here, the holding key part 243 bends and extends to be orthogonal to the elastic part 241b, and is preferably arranged by extending on each of the opposite sides of the pattern key 230 such that each of the holding key parts has the same height and thickness. Furthermore, a holding step 243b by which an end part of the rear end of the pattern key 230 is held is formed on the inside of the holding key part 243. Furthermore, inclined guide surfaces 243c are formed on the outer edges of the holding key parts 243. When the elastic part 241b is pressed by each of opposite external forces, the elastic part 241b is elastically transformed such that the holding key parts 243 approaches each other, and the holding key parts are in close contact with the pattern key 230. Each of the holding key parts 243 has a plate shape, and a holding protrusion 243a held in the holding key holding groove 137b of the inside of the key depression 137 is formed on an end of the holding key part 243 by protruding therefrom to a side thereof. Furthermore, opening interference parts 243d are formed respectively on the rear ends of the holding key parts 243 such that the opening interference parts interfere with a holding protrusion 258b to be described later and a distance between the opening interference parts is increased during the rearward movement of the movable member 251 to be described later. The movement of the holding key 240 having this configuration is controlled by the operation of the manipulation part 250.

The manipulation part 250 is provided with the movable member 251 installed to reciprocate by a predetermined distance inside the movable housing 220, the main manipulation knob 253 connected to the movable member 251, and a sub-manipulation knob 255 connected to the movable member 251.

The movable member 251 is installed such that the movable member 251 can reciprocate by a predetermined distance inside the movable housing 220. The movable member 25 is provided with a movable member body 257 to which the main manipulation knob 253 is coupled, and an operation part 258 which extends from the movable member body 257 and operates the holding key 240. The movable member body 257 is provided with a first coupling part 257a to which the main manipulation knob 253 is coupled, a second coupling part 257b to which the sub-manipulation knob 255 is rotatably coupled, and an elastic protrusion 257c protruding outward from the movable member 251. The first coupling part 257a is formed on the upper surface of the movable member body 257, and the second coupling part 257b is famed by protruding from the rear end of the movable member body 257 to a side thereof. The elastic protrusion 257c is formed by protruding toward the upper surface of the movable member body 257 and is connected to the movable member body 257 so as to be elastically transformed by an external force. Such an elastic protrusion 257c is selectively held by a holding protrusion 223a formed on the upper housing 223 of the movable housing 220 and allows the position of the movable member 251 to be fixed while the movable member 251 is moved forward.

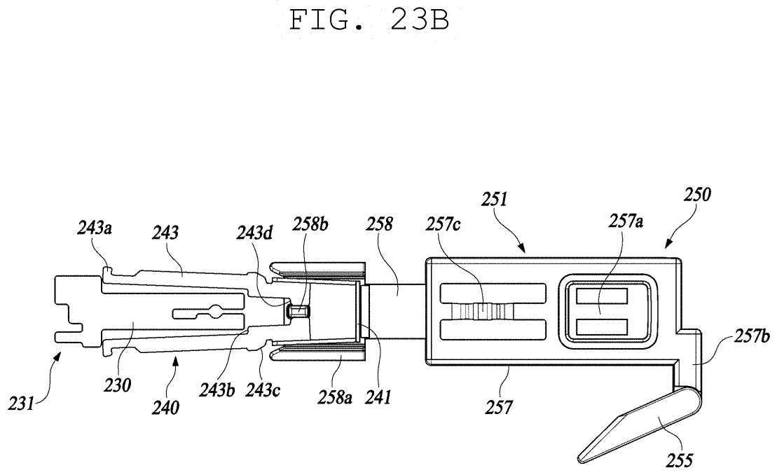

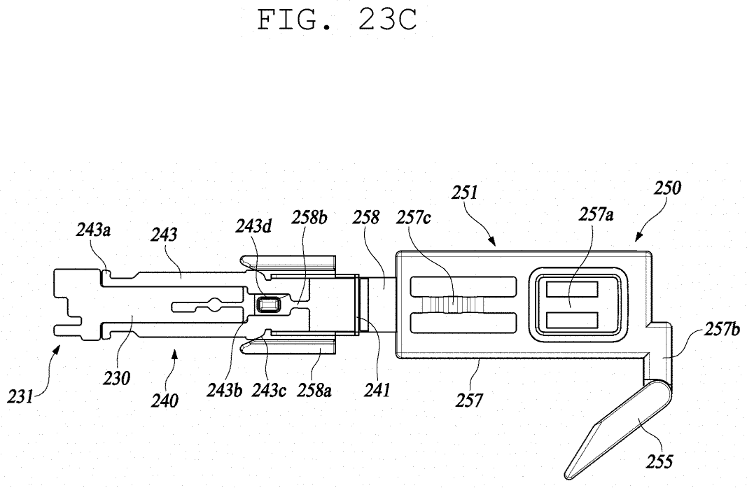

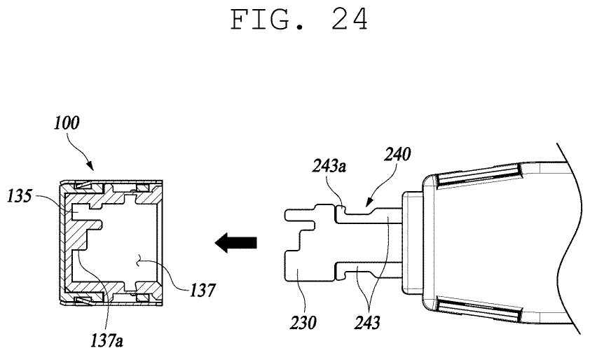

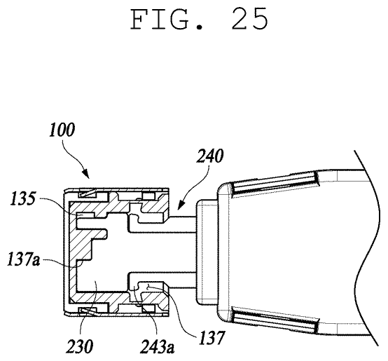

The operation part 258 includes a pair of releasing interference ribs 258a which is provided on the outside of the holding key body of the holding key 240 and supports the holding key body 241, the releasing interference ribs 258a interfering with the holding key parts 243 during the movement of the releasing interference ribs 258a so as to allow the holding key parts 243 to approach each other, and the holding protrusion 258b which is arranged between the releasing interference ribs 258a and allows the holding key parts 243 to be spaced apart from each other. The releasing interference ribs 258a is formed respectively on the opposite edges of the operation part 258 by protruding in parallel with each other, and support the elastic parts 241b of the holding key body 241 at the outside thereof. As illustrated in FIG. 23C, when the movable member 251 moves forward, the releasing interference ribs 258a interfere with the guide surfaces 243c of the holding key parts 243 so as to allow a distance between the holding key parts 243 to be decreased. As illustrated in FIG. 23B, before the movable member 251 moves forward, the holding protrusion 258b is located between the opening interference parts 243d of the holding key parts 243 and prevents a distance between the holding key parts 243 from being decreased. In addition, when the movable member 251 moves forward as much as possible, the holding key parts 243 move out of the holding protrusion 258b and interfere with the interference ribs 258a. Accordingly, the distance between the holding key parts 243 is decreased as illustrated in FIG. 23C, and thus the holding key parts 243 can enter the key depression 137. When the movable member 251 is moved rearward by a predetermined distance by manipulating the main manipulation knob 253 or the sub-manipulation knob 255 after the holding key parts 243 enter the key depression 137, the distance between the holding key parts 243 is increased by the holding protrusion 258b as illustrated in FIG. 26, and inside the key depression 137, the holding protrusion 243a is held in the holding key holding groove 137b as illustrated in FIG. 26.

The main manipulation knob 253 is exposed to the outer side of the body casing 210 so as to be connected to the movable member 251, and can reciprocate along the guide slit 213a. The sub-manipulation knob 255 has an end connected rotatably to the second coupling part 257b, and can protrude from the side surface of the body casing 210 through an inclined hole 215 formed in the side surface of the body casing 210. Accordingly, when the sub-manipulation knob 255 protrudes through the inclined hole 215, a user may easily manipulate the sub-manipulation knob 255 in a narrow environment in which it is difficult to manipulate the main manipulation knob 253 so as to perform the holding of the holding key 240.

The effect of the operation of the port lock apparatus of an electronic device having the above configuration according to the embodiment of the present disclosure will be described in detail.

First, as illustrated in FIGS. 7 to 10, while the pattern module 130 is located at the unlocking position, the lock module 100 is inserted into the port 20 of an electronic device. In this case, since the main locking member 115 does not interfere with the pattern module 130 yet, the lock module 100 is in a state in which the lock module 100 is not coupled yet inside the port 20.

In this state, the pattern module 130 protruding from the front end of the module frame 110 is pushed into the module frame 110. In this case, as illustrated in FIGS. 11 to 14, the pattern module 130 interferes with the main locking member 115 while being moved to the locking position and elastically pushes the second elastic piece 23e, and thus the locking protrusion part 115b is held in the locking hole 23f. In this state, the lock module 100 is held so that the lock module 100 does not come out of the port 20 freely.

In addition, when the pattern module 130 moves to the locking position, the end part of the sub-locking member 125 is held by the holding jaw 135. In this case, since the holding jaw 135 interferes with the sub-locking member 125, the pattern module 130 is prevented from being moved to an initial unlocking position, and thus the lock module 100 may be inserted into and securely held in the port 20, and the lock module 100 may not be arbitrarily removed from the port 20.

Meanwhile, as described above, in order to remove the lock module 100 which is coupled to and locks the port 20, the unlocking key 200 may be used.

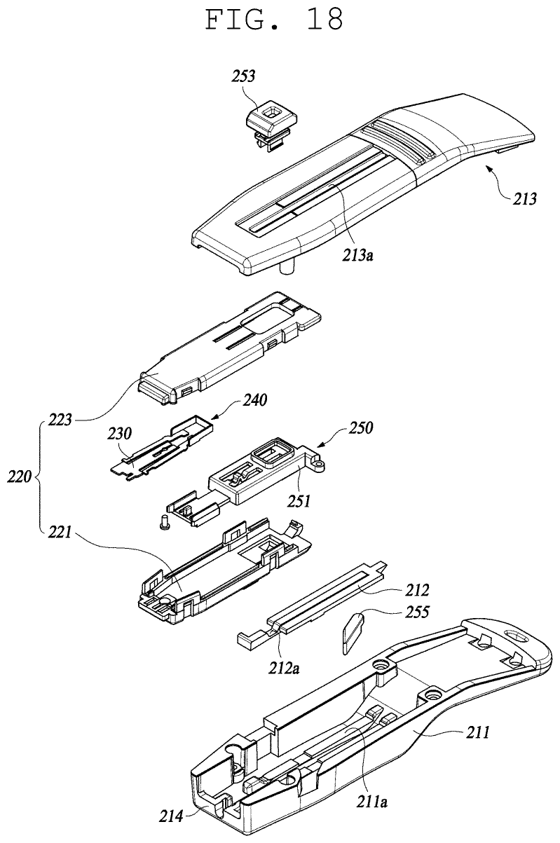

That is, as illustrated in FIG. 17, when the main manipulation knob 253 is pushed forward, the movable housing 220 protrudes from the front end of the body casing 210, and in this state, when the main manipulation knob 253 is further pushed forward, the holding key parts 243 of the holding key 240 approach each other to be in close contact with the opposite sides of the pattern key 230.

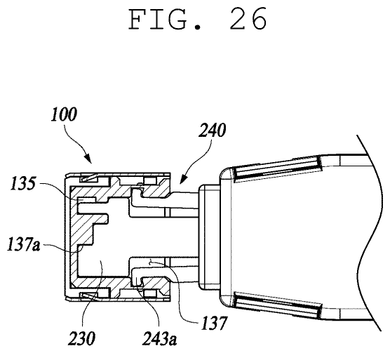

The pattern key 230 and the holding key 240 are inserted into the key depression 137 of the lock module 100. In this case, as illustrated in FIGS. 15 and 25, the pattern key 230 is inserted into the key depression 137. The pattern key 230 may be completely inserted into the key depression 137 only when the pattern of the pattern key 230 and the pattern part 137a of the key depression 137 are in agreement with each other.

When the pattern key 230 is completely inserted, as illustrated in FIG. 15, the pattern key 230 pushes the sub-locking member 125 and removes the sub-locking member 125 from the holding jaw 135.

In this state, the main manipulation knob 253 of the unlocking key 200 is pushed to be moved rearward by a predetermined distance. In this case, as illustrated in FIG. 26, a distance between the holding protrusions 243a of the holding key 240 is increased. In this case, each of the holding protrusions 243a is held in the holding key holding groove 137b defined inside the key depression 137.

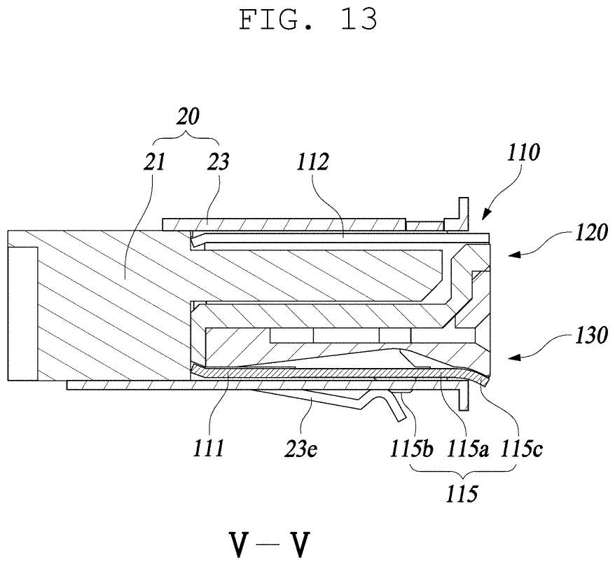

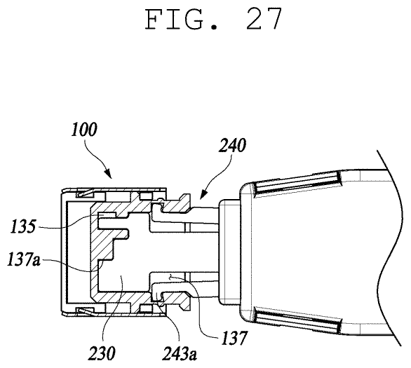

In this case, when the unlocking key 200 is pulled in the state of FIG. 26, the pattern module 130 is moved out by a predetermined distance and is moved to the unlocking position as illustrated in FIG. 27. In this case, as illustrated in FIGS. 12 to 14, the main locking member 115 is elastically restored to an initial position and is released from the locking hole 23f. In this case, when the unlocking key 200 is further pulled, the lock module 100 may be naturally removed from the port 20.

As described above, according to the present disclosure, the lock module 100 may be inserted into the port 20 so as to easily lock the port, thereby locking the port 20 securely.

In addition, as for the unlocking of the port 20, the unlocking key 200 including the pattern key 230 having a pattern corresponding to the pattern part 137a of the inside of the key depression 137 of the pattern module 130 is required to remove the lock module 100 from the port, thereby improving security.

Particularly, the pattern key 230 and the holding key 240 operate independently of each other, and the role of the holding key 240 is subordinated by the shape of the pattern of the pattern key 230, so the lock module 100 may not be removed by an unauthorized unlocking key 200. Furthermore, the forcible removal of the lock module 100 by an unauthorized tool such as a clip or tweezers can be fundamentally prevented, thereby improving security.

In the above, the present disclosure has been illustrated and described in relation to the exemplary embodiment for illustrating the principle of the present disclosure, but the present disclosure is not limited to the configuration and operation as shown and described as such. Rather, it will be appreciated by those skilled in the art that many changes and modifications to the present disclosure are possible without departing from the spirit and scope of the appended claims.

What is claimed is:

1. A port lock module for an electronic device, the port lock module comprising:
a module frame famed by corresponding to size and shape of a port of an electronic device and having a frame shape having open opposite ends, the module frame having a main locking member configured to be transformed outward by an external force so as to be held in or released from a locking hole formed in the port;
a locking module having a locking module body fixedly installed inside the module frame, and a sub-locking member connected to the locking module body such that the sub-locking member is elastically transformable; and
a pattern module being installed to move inside and outside of the module frame between a locking position and an unlocking position, wherein when the pattern module is inserted to the locking position, the pattern module interferes with the main locking member such that the main locking member is held in the locking hole, the pattern module having a key depression into which an unlocking key for removing the sub-locking member from a holding jaw by which the sub-locking member is held is inserted.

2. The port lock module of claim 1, wherein the locking module body comprises:
a horizontal part located between an upper wall and a lower wall of the module frame, wherein a fixing groove to which a fixing protrusion formed on the module frame is coupled is formed in each of opposite sides of the horizontal part, and a through hole is formed in a center of the horizontal part such that the sub-locking member connected to the horizontal part so as to be elastically transformable is received in the through hole;
an entrance blocking part formed by extending upward from a front end of the horizontal part so as to partially block an entrance of the module frame; and
a guide rib formed by protruding downward from each of opposite side edges of the horizontal part, wherein a guide groove which limits a reciprocating distance of the pattern module is formed in the guide rib.

3. The port lock module of claim 2, wherein the main locking member is formed to be inclined from the lower wall of the module frame toward the inside of the module frame such that the main locking member is in contact with the pattern module, the main locking member having a locking protrusion part locked in the locking hole of a port frame while the pattern module moving to the locking position moves in contact with a free end part of the main locking member.

4. The port lock module of claim 3, wherein the main locking member is formed at a position corresponding to a position of an elastic piece formed on a lower wall of the port frame.

5. The port lock module of claim 2, wherein the sub-locking member is formed to be inclined toward the pattern module from a first end of the sub-locking member connected to an inner wall of the through hole to a second end of the sub-locking member, wherein the second end of the sub-locking member extends by protruding to a lower side of the locking module body such that the second end is held by the holding jaw formed in the pattern module moving to the locking position.

6. The port lock module of claim 1, wherein the pattern module comprises:
a plate-shaped pattern module body configured such that the key depression is exposed to front and lower surfaces of the pattern module body; and
a guide protrusion formed by protruding from each of opposite side edges of the pattern module body,
wherein a pattern part to which a pattern key of the unlocking key is coupled, and a holding key holding groove to which a holding key of the unlocking key is coupled are respectively formed in inner different surfaces of the key depression, and
wherein a reception and guide groove for interfering with the main locking member is formed in a lower part of the pattern module body.

7. A port lock apparatus of an electronic device, the port lock apparatus comprising:
the lock module of claim 1, and
an unlocking key comprising: a pattern key inserted into a key depression by protruding from a front end of an unlocking key body so as to interfere with a sub-locking member such that a pattern module is removed from a locking module to be unlocked, and a holding key installed movably on an outer side of the pattern key and configured to expand inside the key depression to be held in the key depression such that the pattern module is moved to an unlocking position.
